(19) United States
(12) Patent Application Publication
(10) Pub. No.: US 2023/0074160 A1
(43) Pub. Date: Mar. 9, 2023

(54) ADAPTIVE TIRES TRACTION CONTROL

(71) Applicants: Wadih Geahchan, Mansourieh Maten (LB); Karim Geahchan, Paris (FR)

(72) Inventors: Wadih Geahchan, Mansourieh Maten (LB); Karim Geahchan, Paris (FR)

(21) Appl. No.: 17/429,424

(22) PCT Filed: Apr. 1, 2021
(86) PCT No.: PCT/EP2021/058726

§ 371 Date: Aug. 9, 2021

(51) Int. Cl. B60C 19/00; B60C 11/00; B60C 11/16; B60G 3/06; B60G 3/26; B60C 3/06

(52) U.S. Cl. CPC B60C 19/001; B60C 11/0066; B60C 11/16; B60G 3/06; B60G 3/26; B60C 3/06; B60G 2200/14; B60G 2200/46; B60G 2202/413; B60G 7/003

(57) ABSTRACT

An adaptive tire traction control system for motor vehicle tires for grip enhancement and rolling friction reduction. The tire surface area is radially divided into multiple zones, in the three zones configuration the tire is composed of an outer shoulder, centre and inner shoulder. The outer shoulder is equipped with a plurality of studs to increase the traction when vehicle is on icy or muddy surfaces. The centre part is made of low friction rubbers for the normal operation to increase fuel economy and lengthen the tires life, and reduced rolling noise. The inner shoulder is equipped with high grip rubber to provide better grip in case of emergency braking. In one embodiment, the tilting mechanism of the tire traction system can be connected to the anti-lock braking system (ABS). In case of emergency braking, the inner shoulder with high grip rubber is brought in contact with the ground to provide more grips.

### TECHNICAL FIELD

The present invention generally relates to adaptive tires traction control and more particularly to automotive vehicles tires grip with pavement, rolling friction, and braking system. Moreover, the present invention relates to tires grip enhancement only when needed thereby reducing tires friction and improves fuel consumption in normal running conditions, further tires life cycle is also lengthened.

### BACKGROUND OF THE INVENTION

Attributable to the extreme weather conditions around the globe, ranging from snow to desert regions, automobile operators have always tried to dig out a solution to improve tires grip of vehicles. Typically, automobile operators living in cold regions experience the challenges of snow covered roads. For people living in such areas it is necessary for them to cope up with the possibility that at times roads may be snow or ice covered. Hence, this possibility of snow covered roads frequently necessitates changing the tires to snow or studded tires or the addition of snow chains to provide greater traction during such events. Additionally, the weather conditions changes from time to time and does not remain the same throughout the year. Hence, in the winter season when the roads are covered with snow, enhanced traction tires or snow chains are incorporated. On the other hand, when the weather changes to a warmer temperature, it is required to remove the enhanced traction tires or chains. Moreover, changing tires or removing the snow chains can be time consuming and costly. While studded tires may be permanently used in some states during a designated snow season, these tires have a speed limit and they tend to tear up roadways thus leading to high maintenance costs.

The best way to improve tires grip on dry pavement is to use tires with high grip rubber. However, the drawback of using high grip rubber is that high grip rubber wears rapidly rendering tires life very short, and results an increase in rolling friction. Manufacturers seek finding the right balance between low friction and high grip rubber to optimize the tires performance in term of the three pillars; rolling friction, grip, and tires life span. But the perfect rubber does not exist and as a result compromises are always made in one or more of these three pillars.

However, a durable highly efficient tire for all weather conditions has not been developed till date. There has been no such advancement to provide an all-weather tire able to provide high grip with pavement during braking and on slippery, icy, and snowy conditions. Moreover, no such invention has come up to provide enhanced grip in all weather conditions without the need to change tires or install/remove snow chains every season.

A number of solutions were introduced in order to solve the abovementioned problems but most are too expensive or unpractical to develop and implement. In one of the closest relevant arts, U.S. Pat. No. 9,278,584 B2 discloses that all-weather tire includes features that enhance safety and usability in a variety of driving conditions as well as some manufacturing processes that may be used during the production and provides an all-weather tire having selectively deployable and retractable studs for greater traction when needed. The tire includes a toroidal shell enclosing an air-filled chamber and a plurality of stud actuation chambers contained within the shell for selectively deploying studs to extend past the tire's outer radial surface for engaging a roadway or surface. The studs may be retracted when no longer needed. A mechanical pump assembly or plurality of such assemblies powered by compression of the tire engaging the roadway may be used as a power source for generating pneumatic pressure and an internal valve assembly or assemblies may be used to route the pneumatic pressure appropriately. The pump and valve assemblies may be controlled either mechanically or electrically.

Another relevant art JPH0986116 A discloses to eliminate use of a studless tire yet imperfect in non-skid performance during travelling a vehicle on ice, to eliminate troublesome and dangerous connection and disconnection work of a chain in midwinter, to reduce an economic burden of the owner of the vehicle, to contribute to resource saving and energy saving, to remove mental stress of worrying when the vehicle skids in a cold district and to secure safety travelling. This non-skid tool to use by covering a tire 1 with it uses a steel belt carbon fibre uniform article for a core material, wraps both surfaces of the core material with soft rubber and makes a large number of conical protruded parts to bite into the tire on the inside of it, and a tread is simultaneously moulded with the soft rubber 10 wrapping the core material 15 and has studs on its important points, and a coupler metallic fitting buried in coupler hard rubber is installed on a coupler part.

Another relevant art JP2009051314 aims to provide a tire for a two-wheeled vehicle that achieves both improvement in wear resistance of a tread shoulder portion and improvement in steering stability during turning by improving lateral grip. A pneumatic tire for a motorcycle includes a carcass, a spiral belt, and a tread portion. A high loss tangent rubber portion 22 is formed on the tread surface side of the tread end portion 18E. The high loss tangent rubber portion 22 has a developed width W from the tread end T within a range of 5 to 14% of the tread developed width L, and is compared to the center side rubber portion 26 adjacent to the tire center side has been raised. Further, in at least a part of the region S where the development width from the tread end T is 25% or less of the tread development width, on the outer side in the tire radial direction of the spiral belt 16, the high loss tangent rubber portion 22 and the center side rubber portion 26 are provided. A low-loss tangent rubber portion 28 having a smaller loss tangent tan 6 is disposed.

Another relevant non-patent literature “Michelin power pure sc, the world's first dual compound scooter tire” discloses that the intent of introducing this technology is to increase the grip of the tires while going through corners (it's when the highest grip is needed to avoid slipping). When going through corners the bikers is forced to lean the bike to maintain balance, when doing so the tire part engaging the road changes, as such the soft rubber comes into contact with the road since the shoulders are composed of soft high grip rubber. In other words Michelin has only introduced this technology for motorcycles tires since the tire soft and hard rubbers are engaged naturally when the driver leans on corners.

Another relevant art U.S. Pat. No. 6,336,487 B1 discloses a pneumatic tire which is used for a vehicle and obtained after a rubber material is formed by vulcanization. A cap portion (12A), which is an upper layer of a tread and directly contacts the road surface, is a foam rubber which includes innumerable elongated closed cells (24). The outer portion of the elongated closed cell (24) is coated by a resinous protective layer (26). During the vulcanization process of the tire, a resin whose viscosity is lower than that of a rubber matrix and a blowing agent which generates gas are kneaded with a rubber material so as to obtain a rubber composition. The rubber composition is formed in the shape of a band and adhered to a crown portion of a raw tire casing. The resin is melted by the heat of vulcanization and the viscosity of the resin is lower than that of the rubber matrix. The gas generated in the rubber moves toward and concentrates at the inner side of the resin. Accordingly, an elongated closed cell (24) whose outer portion is provided with the resinous protective layer (26) is formed.

Another relevant art US20110088823 A1 discloses a tire includes a carcass, a tread band having a radially outer tread surface and a plurality of radially extending recesses, and an anti-slip structure disposed in one of the radially extending recesses. The anti-slip structure includes a first circular inner portion, a second outer portion, and a third core portion. The third core portion comprises an assembly of three pin structures for providing traction over ice. Each pin structure has a wedge-shaped base portion secured within the first circular inner portion and a pin extending through the second outer portion to the tread surface. The three wedge-shaped base portions combine to form a circular base portion for the assembly.

Conventional methods of improving tires grip do not provide a durable highly efficient tire for all weather conditions by improving tires grip with pavement during braking and on slippery, icy, and snowy conditions. The conventional methods do not offer enhanced grip in all weather conditions without the need to change tires every season. Furthermore, no such method has been developed to provide tires grip enhancement when needed, thereby reducing tires friction and improving fuel or battery efficiency in normal running conditions.

The prior arts described above, indicate that some studies have been carried out to provide an all-weather tire. But still there remains a need to develop a combination of rubber composition that provides the highest grip and minimum wear. Furthermore, there is a need to utilize a composite tire with two or more different rubber belts one having a low friction rubber with low rolling friction and wear, the second having a rubber with high grip that can provide increased grip during emergency breaking. Moreover, it is required that the car wheels be tilted mechanically to engage the appropriate rubber belt when needed, thereby overcoming the problems of the conventional grip improving methods.

The present invention solves the problem of providing improved tires grip with the road when needed during braking and slippery conditions such as icy, snowy or muddy conditions by tilting the wheels and allowing the most suitable rubber or tire construction to engage the road. A further benefit of the present invention is that during braking mode the tires are tilted outward thus widening the vehicle contact points with the ground and providing improved stability during braking. A further benefit of the present invention is that the use of curved tires provides enhanced fuel or battery efficiency by reducing the tires contact with the ground and because during normal operating mode the low friction rubber is in contact with the ground. Another benefit of the present invention is enhanced tires life cycle since during normal operating mode the central part of tires is constructed of hard durable rubber. The side shoulders with high grip rubber only engage the road during braking, or when sliding is detected. Not only the present invention provides longevity to the tires but also ensures safety of the automobile driver.

All the problems, disadvantages and the limitations of the above mentioned relevant and conventional arts being overcome by the method of the present invention which has various technical advancements and certainly the economic benefits over the conventional arts.

### SUMMARY OF INVENTION

It is an object of this invention to provide an adaptive traction system achieved by changing the contact point of the tire using a tilt mechanism for normal, snow, mud, ice tracks and emergency braking quickly without the need for either the operator skill or physical strength.

The present invention provides an adaptive tire traction system for vehicle, the adaptive tire comprising:
a toroid shell enclosing an air filled chamber or any other 3D structure material, solid, liquid or gas that helps maintain the tire shell shape and desired performance and having a radial surface; and
a plurality of stud on the radial surface;
   characterized in that
   wherein the radial surface of toroid shell further comprise:
an outer shoulder of radial surface includes the plurality of stud fixed to hard rubber at desired distance, wherein the outer shoulder engage the road surface when the tire is tilted outward to the desired angle;
a central radial surface includes low friction rubber with gripping grooves or a flat surface for normal operation, wherein the low friction rubber provide normal grip on the road;
an inner shoulder of radial surface includes high grip rubber, wherein the high grip rubber increase the grip on the road surface when the tire is tilted inward to is the desired angle;
   wherein a tilt angles is calibrated to allow contact of single radial surface at a time; and
   wherein the inward tilting can be linked to a ABS system of the vehicle or a dedicated slip detection system.

In one embodiment of the present invention, the outer shoulder of radial surface with studs engages to road when tilted outward for snowy, ice and mud conditions.

In one embodiment of the present invention, the central radial surface with low friction rubber remains engaged in normal running condition.

In one embodiment of the present invention, the inner shoulder of radial surface with high grip rubber engages to road when tilted inward for increasing traction for emergency braking or slippery roads.

In one embodiment of the present invention, the tire tilting mechanisms is connected to the ABS system or any other automatic activation mechanism of the vehicle to automatically tilt the tire at required angle for increased grip.

In one embodiment of the present invention, the tilt mechanism is achieved using hydraulic piston or any other mean to tilt the wheel to desired angles.

In accordance with these and other objects which will become apparent hereinafter, an enhanced traction system is developed for a motor vehicle tires for use in all weather conditions. The tire surface area can be divided into two or three different zones. In the three zones configuration, the tires have three distinct rubber compositions each laid on a different shoulder; the outer shoulder, the central Part and the inner shoulder. The outer shoulder is equipped with a plurality of studs to increase the traction when the vehicle is on an icy surface. The central part is made of low friction rubber for the normal operation to increase fuel and battery efficiency. The inner shoulder is covered with high grip rubber to provide better grip in case of emergency braking.

In one embodiment, the tilt mechanism of tire traction system is connected to the anti-lock braking system (ABS) so that in case of emergency braking, the wheels are tilted such that the inner shoulder with high grip rubber is brought in contact with the ground to provide more grip. The activation of tilt mechanism can be triggered by the ABS sensors connected to ABS system or any other slip detection system.

The Adaptive Tires Traction system can include modular units that can be connected into the supports for configuring varied sizes of tires.

### BRIEF DESCRIPTION OF DRAWINGS

FIG. 1 composite tire with low friction rubber belt at the centre, high grip rubber belt on the inner shoulder, and metallic studs belt on the tire outer shoulder. The tire is shown in the three operating positions;

FIG. 2 sketch is one example on how the adaptive traction system can be incorporated with the double wishbone suspension system with the hydraulic piston replacing the upper wishbone, used for wheel tilting.

FIG. 3 Outward tilted wheel installed on a double wishbone suspension with metal studs shoulder engaging the ground.

FIG. 4 straight positioned wheel installed on a double wishbone suspension with low friction rubber belt engaging the ground.

FIG. 5 Inward tilted wheel installed on a double wishbone suspension with high grip rubber shoulder engaging the ground.

FIG. 6 An alternative tire profile compatible with the invention with polygon like profile instead of a curved profile, with multiple faces where each face has a different rubber composition.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein achieve this by providing a system to achieve adaptive traction control by using a curved composite tire, where-by the tires shoulders are constructed differently than the central part of the tires. The wheel is attached to a tilting mechanism for the inward and outward tilting of the tire as per the required traction.

The FIGS. 1, 2, 3, 4, 5 and 6 represent each position of tire traction in different scenarios and the functioning of different contour. The present invention proposes the use of a curved, polygonal or any composite tire profile, where by the tires shoulders are constructed differently than the central part of the tires.

FIG. 1 shows the use of all the profiles with respect to different use. In FIG. 1(a), the wheel (101) is tilted inward allowing the high grip rubber to engage the road during emergency breaking and slippery roads. In FIG. 1(b) The wheel (101) is kept in the vertical position for the low friction rubber to engage the road and reduce friction when running on paved surfaces. The external shoulder can be made of hard rubber with metal studs that can provide enhanced grip on icy, snowy or muddy roads. In FIG. 1(c) The wheel (101) is tilted inward allowing the metal studs to engage the road on icy and snowy road. In another possible arrangement the outer shoulder with metal studs can be replaced with a surface profile suitable for mud with deep groves.

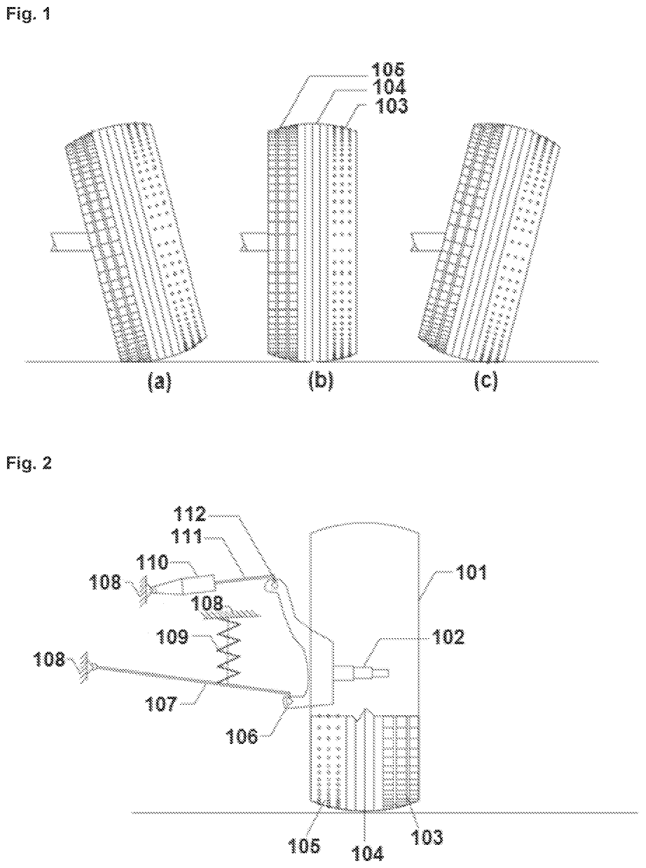

FIG. 2 shows the wheel (101) attached to the spindle (102), where the wheel (101) is equipped with required profile type tire. The spindle (102) is connected to the suspension system of the vehicle with the help of lower ball joint (106) and upper ball joint (112). The lower ball joint (106) is connected to the lower wish bone (107). The lower wish bone other end is connected to car frame (108) and in mid-section is attached to spring and damper (109). The upper ball joint (112) is connected to hydraulic piston arm (111) which is connected to hydraulic piston (110). The hydraulic piston (110) is connected to car frame (108).

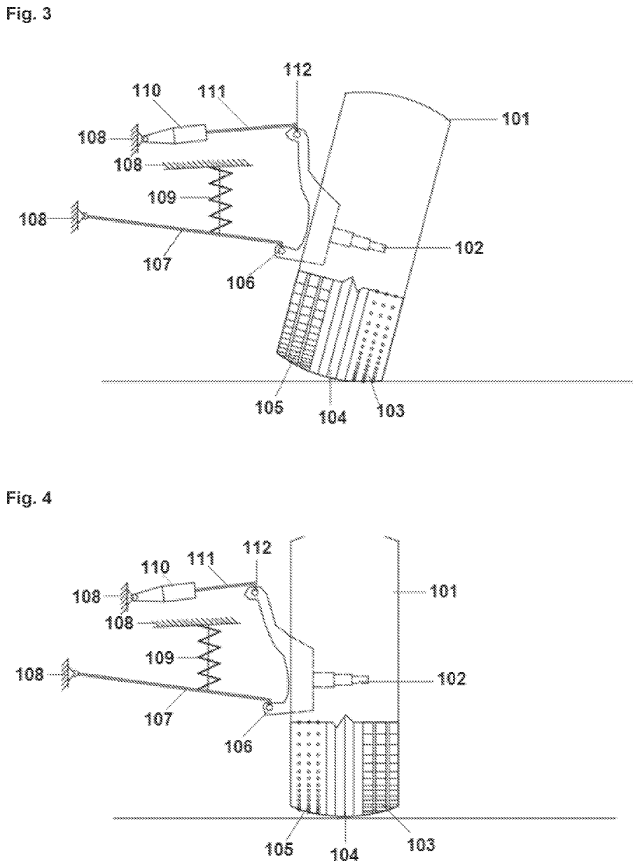

FIG. 3 show the front view of the wheel (101) in the outward tilted position, allowing the studded belt to engage the road. The hydraulic piston (110) attached to car frame (108) is actuated to expand by external means. The hydraulic piston arm (111) connected to the piston starts to move away from the body frame and pushs the upper ball joint (112) outward. As the upper ball joint (112) move from its central position in an outward direction, it forces the wheel (101) attached to spindle (102) to tilt outward. The outer radial surface (103) is engaged with the ground to provide traction on icy, snowy or muddy roads. The outer radial surface (103) is equipped with studs on a rubber belt at proper distance and structure to provide necessary grip as well as proper traction when engaged with the ground. The studs are none movable and fixed to the profile of the wheel (101). So there is no requirement of manual implementation during icy condition. The studs can be made of metal or any other material able to achieve the designer intent.

FIG. 4 shows the front view of the wheel (101) when kept vertical. The central radial surface (104) is of low friction rubber. The low friction rubber covering the central belt can be provided with grooved texture to provide necessary grip and reduced rolling noise and friction during normal operation. Due to the low friction rubber, the friction of the central radial surface with the ground is reduced, allowing longer life of wheel (101), less wear and tear, and better fuel economy or battery saving for electric cars. The wheel (101) works as a normal tire when it is in the vertical position. The wheel (101) remains in the normal position until the user requires extra grip or when slipping is detected.

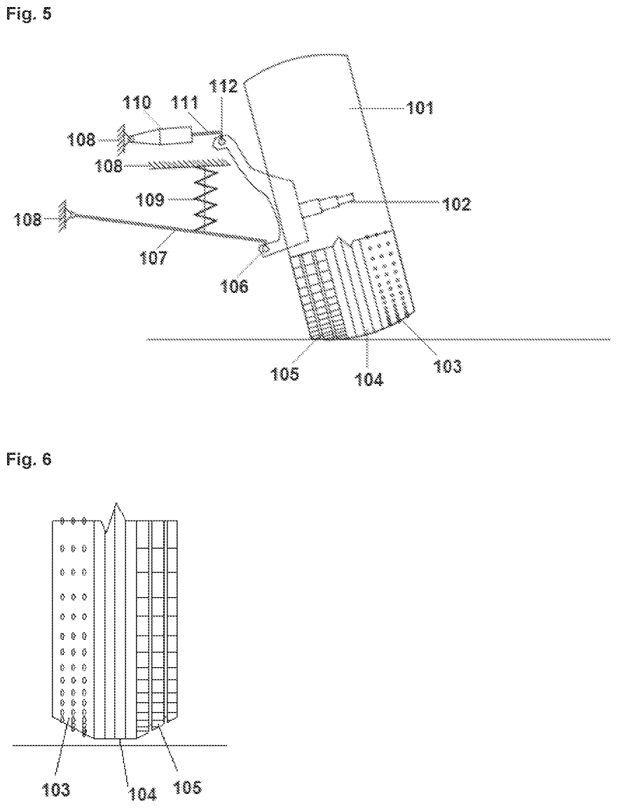

FIG. 5 shows the front view of the wheel (101) when tilted inward. The hydraulic piston (110) attached to car frame (108) is actuated to tilt the wheel by external means. The hydraulic piston arm (111) connected to the hydraulic piston start to move inward toward the body frame and pulls the upper ball joint (112) inward. As the upper ball joint (112) moves from its central position to inward direction, it forces the wheel (101) attached to spindle (102) to tilt inward. The inner radial surface composed of high grip rubber (105) is engaged with the ground to provide traction in case of emergency braking or when extra grip is required. The activation of this setting can be connected to the anti-lock braking (ABS) system or any other automatic activation system.

FIG. 6 instead of a curved profile the tire can have a polygonal profile with multiple faces constructed of different materials and rubber similar to the curved profile tire described in FIGS. 1-5. Having polygonal faces allows the increase of the tire contact area with the ground if needed. In another possible alteration some of the faces can be made curved while others flat.

In enhanced breaking mode the tilting mechanism response time needs to be very rapid. It can be linked to the car ABS system or it could be triggered by a dedicated tires slip detection system. The proposed system can be operated in conjunction with the ABS system to provide safety for the driver and passengers.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. An adaptive tire traction system for vehicle, the adaptive tire comprises:
a toroid shell enclosing an air filled chamber or any other 3D structure material, solid, liquid or gas that helps maintain the tire shell shape and desired performance and having a radial surface; and
a plurality of stud on the radial surface;
characterized in that
wherein the radial surface of toroid shell further comprise:
an outer shoulder of radial surface includes the plurality of stud fixed to hard rubber at desired distance, wherein the outer shoulder engage the road surface when the tire is tilted outward to the desired angle;
a central radial surface includes low friction rubber with gripping grooves or a flat surface for normal operation, wherein the low friction rubber provide normal grip on the road;
an inner shoulder of radial surface includes high grip rubber, wherein the high grip rubber increase the grip on the road surface when the tire is tilted inward to the desired angle;
wherein a tilt angles is calibrated to allow contact of single radial surface at a time; and
wherein the inward tilting can be linked to a ABS system of the vehicle or a dedicated slip detection system.

2. The adaptive tire traction system for vehicles as claimed in claim 1, wherein the outer shoulder of radial surface with studs engage to road when tilted outward for snowy, ice and mud conditions,

3. The adaptive tire traction system for vehicle as claimed in claim 1, wherein the central radial surface with low friction rubber remain engaged in normal running condition.

4. The adaptive tire traction system for vehicle as claimed in claim 1, wherein the inner shoulder of radial surface with high grip rubber engage to road when tilted inward for increasing traction for emergency braking or slippery roads.

5. The adaptive tire traction system for vehicles as claimed in claim 1, wherein the tire tilting mechanisms connected to the ABS system or any other automatic activation mechanism of the vehicle to automatically tilt the tire at required angle for increased grip.

6. The adaptive tire traction system for vehicle as claimed in claim 1, wherein the tilt mechanism is achieved using hydraulic piston or any other mean to tilt the wheel to desired angles.
